(19) United States
(12) Patent Application Publication
(10) Pub. No.: US 2008/0302397 A1
(43) Pub. Date: Dec. 11, 2008

(54) Device For Cutlery Stacking in Dishwashers

(75) Inventors: Alexander Bühlmeyer, Bopfingen (DE); Gerhard Egger, Altenmünster (DE); Rainer Schütz, Neresheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munich (DE)

(21) Appl. No.: 11/658,248

(22) PCT Filed: Jul. 13, 2005
(86) PCT No.: PCT/EP05/53365

§ 371 Date: Jan. 22, 2007

(30) Foreign Application Priority Data
Jul. 23, 2004 (DE) 10 2004 035 727.7
Jul. 23, 2004 (DE) 20 2004 020 379.0

(51) Int. Cl. B08B 3/00

(52) U.S. Cl. 134/85; 134/137; 134/164

(57) ABSTRACT

A device for stacking cutlery pieces is provided by means of which cutlery pieces may be easily accessible and can be housed in a space-saving and tidy manner in the rinsing chamber of a dishwashing machine. The device provides reliable isolation and easy loading and unloading of cutlery pieces. A pivoting stacking device is arranged on an external side of the washing-up basket and includes a holder, in which at least one separate cutlery receptacle may be introduced, whereby the cutlery receptacle is characterised by particular aids for individual stacking of the cutlery pieces.

The subject matter of the present invention is a device for stacking items to be washed, in particular for stacking cutlery pieces, in dishwashers. The present invention further relates to a cutlery basket for stacking cutlery pieces in dishwashers.

It is known to arrange the items to be washed in the washing container of a dishwashing machine in one or a plurality of crockery baskets. Such crockery baskets usually consist of a plastic-coated wire mesh and are usually displaceably mounted at the side walls of the washing container so that they can be removed from the washing container when the front door of a built-under dishwashing machine is opened. In order to accommodate cutlery pieces, a separate module in the form of a cutlery basket is frequently provided in the lower crockery basket and this cutlery basket can usually be removed from the crockery basket. A disadvantage of known cutlery baskets is that they are preferably accommodated in the lower crockery basket and are therefore awkward and unergonomic to load. A further disadvantage of known cutlery baskets is that the cutlery pieces can only be accommodated loosely therein and contact one another which can result in damage to the cutlery pieces and in the development of noise and a poor washing result during the washing operation.

It is further known to provide additional knife racks in the area of the upper crockery basket on which the cutlery pieces can be stacked. Such additional knife racks have the disadvantage that they require a large amount of space in the crockery basket which is therefore lost for accommodating further items to be washed. In another known device for stacking cutlery pieces, a cutlery drawer is provided adjacent to the crockery baskets which can be slid in and out in the washing container of the dishwashing machine. However, cutlery drawers have the disadvantage that they cannot hold any bulky cutlery pieces and the installation of an additional drawer increases the manufacturing costs of the dishwashing machine. In addition, stowing height is disadvantageously lost.

Document DE 35 20 148 describes a cutlery basket for a dishwashing machine which is separably connected to a crockery basket which can be slid into the washing container of the dishwashing machine. For easier loading and unloading of the cutlery basket, this is arranged pivotably about a horizontal axis on the front basket wall of the crockery basket. This device has the disadvantage that the cutlery basket can only be separated from the crockery basket in its entirety, wherein the removal and the re-attachment of the cutlery basket to the crockery basket requiring a high accuracy and dexterity, which is associated with increased expenditure.

It is therefore the object of the present invention to provide a device for stacking cutlery pieces in dishwashing machines which allows the cutlery pieces to be accommodated in an easily accessible, space-saving and tidy manner in the washing container at low production costs and which is extremely easy to use. A further object of the present invention is to provide a device for stacking cutlery pieces in dishwashing machines which allows more reliable separation and easy loading and unloading of a crockery basket with cutlery pieces.

These objects are achieved by the crockery basket according to the invention having the features according to claim 1 or by a cutlery basket having the features according to claim 12. Advantageous further developments of the present invention are each characterised in the dependent claims 2 to 11 and in the dependent claims 13 to 22.

The crockery basket according to the present invention has at least one crockery basket provided with a stacking device for arranging items to be washed, especially for stacking cutlery pieces in dishwashing machines, wherein the pivoting stacking device is pivotally arranged on an external side of the crockery basket and comprises a holder in which at least one separate cutlery basket can be inserted. The crockery basket according to the invention can be used for all dishwashing machines which have a washing container which is closed by a hinged door in which at least one crockery basket mounted displaceably on the side walls of the washing container is arranged and which can be withdrawn from the washing container of the built-under dishwashing machine via its front side when the hinged door is open.

As a result of the pivoting stacking device of the crockery basket according to the invention, on the one hand the advantage is achieved that cutlery pieces can be loaded and unloaded without additional aids since the cutlery basket is arranged pivotably in the holder of the stacking device on the external side of the crockery basket. The cutlery pieces are easily accessible on the external side of the crockery basket, in particular if the device for stacking cutlery pieces is arranged on the front side of a displaceably mounted crockery basket which can be withdrawn from the washing container of a built-under dishwashing machine via this front side when the hinged door is opened. On the other hand, the crockery basket according to the present invention has the advantage that the cutlery basket and the crockery basket are completely accessible at the same time.

Since the device for stacking the cutlery pieces is arranged on the external side of the crockery basket in the crockery basket according to the invention, the cutlery pieces can be arranged in a particularly space-saving manner and the inner area of the crockery basket can be used exclusively for stacking items to be washed. The arrangement of the device for stacking cutlery pieces on the external side of the crockery basket further has the advantage that the overall height of the crockery basket is available for stowing cutlery pieces so that large and bulky cutlery pieces or other items to be washed can also be stowed therein. A visible differentiation between dishwashing machines of a standard design and those with more sophisticated equipment both with regard to the function and the visual impression can also be represented better by the configuration of the crockery basket according to the invention.

As a result of the arrangement of the cutlery basket in the upper crockery basket, there is also no longer any need for additional facilities for accommodating cutlery pieces in the lower crockery basket so that the lower crockery basket can be more universally used as a result of the space which has become free. In addition, a better drying result is achieved with cutlery stored in the upper basket, since a higher temperature prevails in the upper area of the washing container during the drying process than that in the lower area of the washing container.

Since the cutlery basket can be inserted in the holder of the pivoting stacking device, the cutlery basket can be removed from the stacking device, which additionally facilitates the loading and unloading of the cutlery with cutlery pieces. Furthermore, the cutlery basket can also be replaced by a differently shaped cutlery basket and thereby adapted to different requirements, such as, for example, requirements specific to particular countries. Further advantages of the crockery basket according to the present invention for dishwashing machines are obtained from the following description of preferred embodiments.

In a preferred embodiment of the crockery basket according to the invention, the holder of the pivoting stacking device is arranged on an external side of the front side of the upper crockery basket. This improves the accessibility of the crockery or cutlery pieces accommodated in the holder of the pivoting stacking device or the cutlery basket compared with an arrangement in the lower crockery basket or inside the crockery basket. This brings about an ergonomic improvement since the loading or removal of cutlery pieces from the cutlery basket located in the upper crockery basket is easier than if the cutlery basket is located in the lower crockery basket or inside the upper crockery basket.

In a further preferred embodiment of the crockery basket according to the invention, a number of separate cutlery baskets can be arranged in the holder of the pivoting stacking device preferably adjacent to one another. The holder of the pivoting stacking device advantageously has guides for this purpose which facilitates the insertion of the cutlery baskets which can be inserted therein. In order to provide the largest possible stacking area for the cutlery pieces or to allow the largest possible cutlery baskets to be received therein, the holder preferably extends over the total width of the crockery basket. To facilitate repair or maintenance work, the holder is preferably arranged so that it can be separated from the pivoting stacking device and therefore from the crockery basket.

According to the invention, the holder of the pivoting stacking device can be pivoted into a folded-in position in which it is aligned substantially perpendicularly and into a folded-out position in which it projects at an angle from the crockery basket. During the washing mode, that is when the crockery basket is pushed in and the door of the dishwashing machine is closed, the holder is located in the folded-in position and the holder can be pivoted into the folded-out position for loading and unloading. In this case, the holder appropriately executes a pivoting movement about a horizontal pivot axis in the lower area of the holder so that the holder of the pivoting stacking device and therefore the cutlery basket can be folded out from the dishwashing machine away from the crockery basket without the crockery basket itself needing to move. The folding out takes place automatically, i.e. through a corresponding position of the centre of gravity of the holder and cutlery basket with respect to the axis of rotation or in a supporting manner, e.g. by a spring, on opening the door. In order to prevent any unintentional pivoting movement of the holder, a clamping or locating mechanism is preferably provided which retains the holder of the pivoting stacking device in the folded-in position.

It is particularly advantageous if the crockery basket can be withdrawn from the dishwashing machine and the holder is pivoted automatically from the folded-in position into the folded-out position with the withdrawal movement of the crockery basket from the dishwashing machine by a mechanism, for example, by means of a link guide. The mechanism of the link guide is preferably configured in such a manner that the holder is pivoted automatically again from the folded-out position into the folded-in position with the insertion movement of the crockery basket into the dishwashing machine.

In a further preferred embodiment, during opening or closing of the hinged door of the dishwashing machine the holder automatically pivots forwards into the folded-out position and back again into the folded-in position, which allows optimal operation of the cutlery basket without withdrawing the upper crockery basket. If no automatic mechanism is provided for coordinating the hinged door or the crockery basket with the holder of the pivoting stacking device, at least one stop is provided which delimits the pivoting movement of the holder between the folded-in position and the folded-out position.

In order that the cutlery basket or baskets can be optimally inserted in the holder of the pivoting stacking device, the holder comprises a front wall and optionally side walls which preferably have at least the height of the cutlery baskets to be inserted therein. In addition, the pivoting stacking device can have at least one handle by which means the pivoting stacking device can be moved between the folded-in position and the folded-out position, the handle preferably being provided on the front wall of the holder of the pivoting stacking arrangement.

The aforesaid object to provide a device for stacking cutlery pieces in dishwashing machines which can reliably separate cutlery pieces and facilitate loading and unloading of the crockery basket is achieved by a cutlery basket for stacking cutlery pieces for insertion in a crockery basket for dishwashing machines of the type described above, whereby the crockery basket comprises removable aids for suitable arrangement and separation of the cutlery pieces.

By this means, the cutlery pieces can be distributed in different planes in the cutlery basket before removal of the aids and the cutlery pieces are positioned in one plane after removal of the aids. The aids are generally removed after the end of the washing program so that the cleaned cutlery pieces can easily be taken up by hand because they are arranged in one plane and, for example, rest on a side wall of the cutlery basket.

The aids can be various devices, e.g. rods, grids or partition walls with or without recesses. These devices can be arranged at any position in or on the cutlery basket. The devices are arranged, for example, at the opening of the cutlery basket. In addition to a pivotable mounting of the cutlery basket, before or after removal of the aids the cutlery basket is twisted into a position such that when the aids are removed, the cutlery pieces come to lie in one plane, e.g. rest on a side wall.

The aids are preferably embodied as continuations with hook-shaped ends. In this case, the hook-shaped ends of the hooked-shaped continuations are each aligned in the same direction.

The cutlery basket according to the invention has the advantage that the hook-shaped continuations form a type of cutlery basket grid by which means the cutlery pieces can be stored separately from one another in the cutlery basket. This can avoid contact between the cutlery pieces during the washing process as far as possible and the best washing results are achieved. As a result of the hook-shaped continuations being aligned in the same direction, the cutlery basket which can be removed from the holder of the pivoting stacking device can be placed on the side so that the cutlery pieces located therein can drop down past the hook-shaped continuations. This effect facilitates the removal of the cutlery pieces from the cutlery basket.

In a preferred embodiment of the cutlery basket, the hook-shaped continuations are arranged on cross struts which preferably extend from one side of the cutlery basket to the opposite side of the cutlery basket. In this case, a number of cross struts having hooked-shaped continuations can be provided and these are preferably arranged at equal distances on the cutlery basket. Advantageously, the hook-shaped continuations are each arranged on opposite sides and preferably in pairs on the cross struts. The hook-shaped continuations can be arranged at equal distances on the cross struts to avoid hooking with cutlery pieces. In this way, an open cutlery basket grid is formed in the cutlery basket, which allows optimal separation of the cutlery pieces in the cutlery basket.

The function of the cutlery basket grid is particularly efficient if the hook-shaped continuations are aligned substantially perpendicularly to the direction of insertion in which the cutlery pieces are inserted into the cutlery basket. If the cutlery basket is removed from the holder of the pivoting stacking device and placed on the side, as a result of the arrangement of the hook-shaped continuations, the cutlery pieces fall downwards through the open cutlery basket grid as a consequence of gravity.

According to a particularly advantageous embodiment of the cutlery basket according to the invention, at least one side wall of the crockery basket can be folded out. In this case, in its closed position the hinged side wall is preferably engaged at least with one of the other side walls of the cutlery basket to secure the hinged side wall in its closed position. Cross struts having hook-shaped continuations can be arranged both on the hinged side wall and also on the opposite side wall of the crockery basket, said struts being arranged in such a manner that in the closed position of the hinged side wall they are positioned at equal distances and parallel to one another.

When the cutlery basket removed from the holder of the pivoting stacking device is placed on its side and the hinged side wall of the cutlery basket is then opened, the cutlery pieces collect on the lower side of the cutlery basket and can easily be removed without the cutlery pieces needing to be taken individually from the cutlery basket grid. In particular, the cutlery basket according to the invention has the advantage that the cutlery pieces can be grasped hygienically by the handle during removal from the cutlery basket and need not be gripped in the front area, thus reducing the risk of injury.

In a further preferred embodiment of the cutlery basket, said cutlery basket has regions with different insertion depths. By equipping the cutlery basket with regions of different insertion depth, suitable storage space is provided in the cutlery basket for cutlery pieces of different length. In this way. cutlery pieces can be arranged in the cutlery basket sorted according to their length, whereby this pre-sorting during arrangement of the cutlery also facilitates the sorting out and returning of the cutlery pieces into the cutlery drawer. This effect is further supported by using two or more cutlery baskets which can be inserted in the holder of the pivoting stacking device at the same time. In order to facilitate the insertion or removal of the crockery basket from the holder of the pivoting stacking device, the crockery basket can be fitted with a handle which preferably projects upwards above the cutlery basket and can thus be conveniently grasped and without any risk of injury from cutlery pieces standing in the cutlery basket.

A crockery basket and/or cutlery basket described above is arranged in a dishwashing machine according to the invention.

The present invention is explained in detail hereinafter using preferred embodiments with reference to the appended drawings. In the figures:

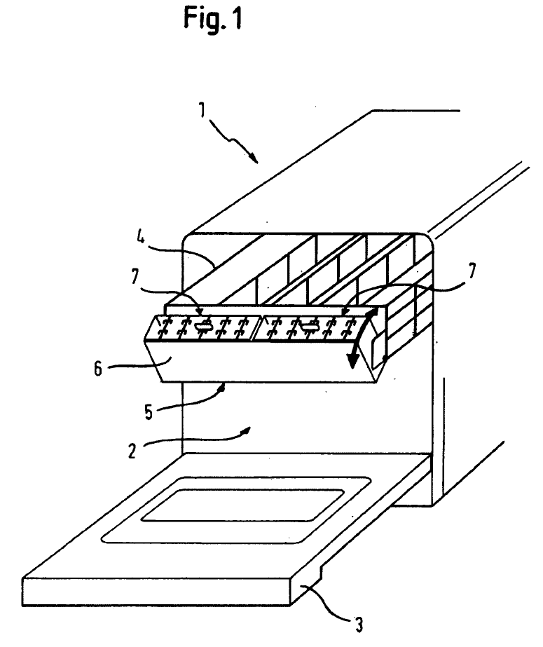

FIG. 1 is a perspective view of a dishwashing machine with a crockery basket according to a preferred embodiment of the present invention;

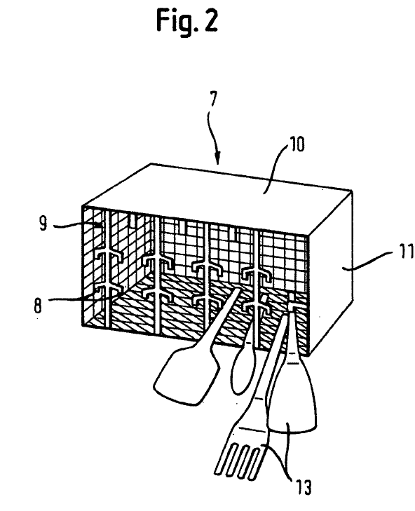

FIG. 2 is a perspective view of a cutlery basket according to a preferred embodiment of the present invention in the closed position; and

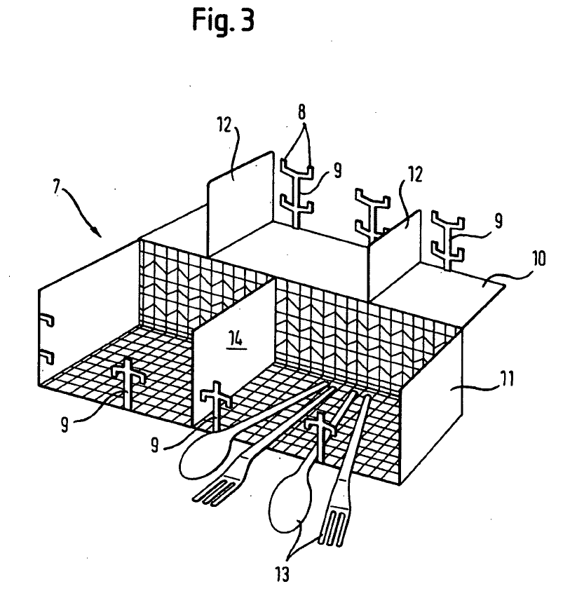

FIG. 3 is a perspective view of a cutlery basket according to the embodiment shown in FIG. 2 in an opened position.

In detail FIG. 1 is a schematic view showing a built-under dishwashing machine 1 comprising a washing container 2 which is closed by a hinged door 3 pivotally mounted on the front side of the dishwashing machine 1. Located in the washing container 2 is a crockery basket 4 which is displaceably mounted on the side walls of the washing container 2 and can thus be withdrawn from the washing container 2 for loading or removal of crockery or cutlery pieces from the washing container 2. In the situation shown in the drawing, the hinged door 3 of the dishwashing machine 1 is opened and the crockery basket 4 is partially withdrawn from the washing container 2.

A pivoting stacking device 5 for stacking cutlery pieces is arranged on the front wall of the crockery basket 4. The pivoting stacking device 5 comprises a holder 6 in which two cutlery baskets 7 are detachably inserted. The holder 6 of the pivoting stacking device 5 has a front wall and side walls which substantially have the height of the cutlery baskets inserted therein. The cutlery baskets 7 can be removed from the holder 6 of the pivoting stacking device 5 for exchange, for maintenance, for loading or for removal of cutlery pieces. The holder 6 of the pivoting stacking device 5 can be pivoted in the directions indicated by the double arrow between a folded-in position in which it is substantially perpendicularly aligned and a folded-out position in which it projects at an angle 4 from the crockery basket. In the situation shown in the drawing, the holder 6 is located in the folded-out position so that the holder 6 projects at an angle of, for example, 45° from the crockery basket 4.

The pivoting movement of the holder 6 is fundamentally independent of the displacement movement of the crockery basket 4. However, the pivoting movement of the holder 6 can be coupled to the insertion or withdrawal movement of the crockery basket 4 and/or with the movement of the hinged door 3 in such a manner that the holder 6 is automatically pivoted from the folded-in position into the folded-out position by a mechanism with the withdrawal movement of the crockery basket 4 and the holder 6 is automatically pivoted back again from the folded-out position into the folded-in position in the inverse direction with the insertion movement of the crockery basket 4 into the dishwashing machine 1. Additionally or alternatively, the pivoting movement of the holder is coupled to the movement of the hinged door 3 of the dishwashing machine 1 in such a manner that the holder 6 is automatically pivoted forwards into the folded-out position when opening the hinged door 3 and is pivoted in the opposite direction back into the folded-in position again when closing the hinged door 3. Additionally, at least one stop is provided which delimits the pivoting movement of the holder 6 between the folded-in position and the folded-out position.

FIG. 2 shows a perspective view of a cutlery basket according to a preferred embodiment of the present invention for stacking cutlery pieces 13. The cutlery basket 7 shown in FIGS. 2 and 3 is suitable for use in a crockery basket 4 according to the present invention. The cutlery basket 7 according to the invention comprises aids for suitable arrangement and separation of the cutlery pieces 13 in the form of continuations 8 with hook-shaped ends. As can be seen in FIG. 2, the hook-shaped ends of the hook-shaped continuations 8 are each aligned in the same direction. In this case, the hook-shaped continuations 8 are aligned perpendicular to the direction of insertion in which the cutlery pieces 13 are inserted into the cutlery basket 7.

In the embodiment of the cutlery basket 7 according to the invention shown in FIG. 2, the hook-shaped continuations 8 are arranged on cross struts 9 which extend from one side to the opposite side of the cutlery basket 7. A plurality of cross struts 9 having hook-shaped continuations 8 are provided, these being arranged at equal distances on the cutlery basket 7. In this case, the hook-shaped continuations 8 are each arranged in pairs on opposite sides and at equal distances on the cross struts 9. In this way, an open cutlery basket grid is formed, allowing optimal separation of the cutlery pieces 13 in the cutlery basket 7. As a result of the alignment of the hook-shaped continuations 8 in one direction, the cutlery basket 7 removed from the holder 6 of the pivoting stacking device 7 can be placed on its side in such a manner than the hook-shaped continuations 8 are directed downwards, as shown in FIG. 2. The cutlery pieces 13 in the cutlery basket 7 can thus drop downwards through the open cutlery basket grid past the hook-shaped continuations 8 and collect there, which facilitates the removal of the cutlery pieces 13 from the cutlery basket 7. The sliding of the cutlery pieces 13 past the hook-shaped continuations 8 can be further promoted if the hook-shaped continuations 8 are not arranged at right angles but at an oblique angle relative to the falling direction of the cutlery pieces 13. A central partition wall 14 and two side partition walls 12, not shown in FIG. 2, are preferably located in the cutlery basket 7.

One side wall 10 of the cutlery basket 7 is preferably embodied in such a manner that it is only connected to the cutlery basket 7 at its lower edge so that the side wall 10 can be turned upwards about the pivot axis of its lower edge. FIG. 3 shows a perspective view of a cutlery basket according to the embodiment shown in FIG. 2 in an opened position. In order to secure the hinged side wall 10 and therefore the cutlery basket 7 in the closed position, the hinged side wall 11 is preferably engaged with the remaining side walls 11 of the cutlery basket 7 in the closed position. Cross struts 9 each having hook-shaped continuations 8 are arranged both on the hinged side wall 10 and on the opposite side wall of the cutlery basket 7 in such a manner that they are positioned at uniform distances from one another in the closed position of the hinged side wall 10 and thereby form an open cutlery basket grid. The cross struts 9 can also each be embodied as continuous starting from one side wall (not shown).

If the cutlery basket 7 is placed on its side and the hinged side wall 10 of the cutlery basket 7 is then opened, as shown in FIG. 3, the cutlery pieces 13 collect on the lower side of the cutlery basket 7. The cutlery pieces 13 can easily be grasped through the opened hinged side wall 10 and removed from the cutlery basket 7. The cutlery basket 7 according to the invention further has the advantage that during removal from the cutlery basket 7, the cutlery pieces 13 can be hygienically gripped by the handle and need not be grasped in the front area.

### REFERENCE LIST

1 Dishwashing machine
2 Washing container of the dishwashing machine 1
3 Hinged door of the dishwashing machine 1
4 Crockery basket
5 Pivoting stacking device
6 Holder of the pivoting stacking device 5
7 Cutlery basket
8 Hook-shaped continuations on the cutlery basket 7
9 Cross struts on the cutlery basket 7
10 Hinged side wall of the cutlery basket 7
11 Side wall of the cutlery basket 7
12 Intermediate walls in the cutlery basket 7
13 Cutlery pieces

1-26. (canceled)

27. A crockery basket mountable in the interior of a dishwashing machine having an access opening for permitting access to the interior of the dishwashing machine, the crockery basket comprising:
a main body area in which items to be washed can be placed, the main body area being delimited by a pair of opposed side walls, a rear wall, and a front wall and the crockery basket being withdrawable outwardly at least partially from the interior of the dishwashing machine such that at least the front wall delimiting the main body area moves outwardly through the access opening of the dishwashing machine; and
at least one stacking device for arranging items to be washed in a dishwashing machine is which the crockery basket may be mounted, the stacking device being pivotally mounted to a side of the crockery basket delimiting the main body area such that the stacking device can pivot relative the main body area and the stacking device including a holder in which at least one separate cutlery receptacle is inserted.

28. The crockery basket according to claim 27, wherein the crockery basket is withdrawable outwardly at least partially from the interior of the dishwashing machine along a plane of withdrawal and the holder of the pivoting stacking device can be pivoted into a folded-in position in which it is aligned substantially perpendicularly to the plane of withdrawal of the crockery basket and into a folded-out position in which it projects at an angle from the crockery basket to the plane of withdrawal of the crockery basket.

29. The crockery basket according to claim 27, wherein the holder is preferably arranged on an external side of the front wall of the mba such that it can be separated from the crockery basket.

30. The crockery basket according to claim 27, wherein the pivoting movement of the holder takes place about a horizontal pivot axis in the lower area of the holder and the holder preferably extends over the entire width of the crockery basket.

31. The crockery basket according to claim 28, wherein the crockery basket can be withdrawn from the dishwashing machine and the holder is pivoted automatically from the folded-in position into the folded-out position during at least one of the withdrawal movement of the crockery basket from the dishwashing machine, during opening of a hinged door of the dishwashing machine, preferably by means of a link guide, during the insertion movement of the crockery basket into the dishwashing machine and during closure of a hinged door of the dishwashing machine that closes the access opening.

32. The crockery basket according to claim 28, wherein at least one stop is provided that delimits the pivoting movement of the holder between the folded-in position and the folded-out position.

33. The crockery basket according to claim 27, wherein the holder of the pivoting stacking device includes a front wall and optional side walls that preferably have at least the height of the cutlery receptacles to be inserted therein.

34. The crockery basket according to claim 27, wherein a number of separate cutlery receptacles can be inserted preferably adjacent to one another in the holder of the pivoting stacking device.

35. The crockery basket according to claim 27, wherein the holder of the pivoting stacking device comprises guides that facilitate the insertion of the cutlery receptacles to be inserted therein.

36. The crockery basket according to claim 28, wherein a clamping or locating mechanism is provided that retains the holder of the pivoting stacking device in the folded-in position.

37. The crockery basket according to claim 28, wherein the pivoting stacking device includes at least one handle by which the pivoting stacking device can be moved from the folded-in position and the folded-out position and the handle is preferably provided on a front wall of the holder of the pivoting stacking arrangement.

38. A cutlery receptacle for stacking cutlery pieces for insertion in a crockery basket for dishwashing machines, comprising:
a receiving area for receiving cutlery pieces; and
aids for suitable arrangement and separation of the cutlery pieces received in the area, the aids being selectively removable from the receiving area.

39. The cutlery receptacle according to claim 38, wherein the cutlery pieces can be distributed in different planes in the cutlery receptacle before removal of the aids and the cutlery pieces are positioned in one plane after removal of the aids.

40. The cutlery receptacle according to claim 39, wherein the cutlery pieces rest on a side wall in one plane after removal of the aids.

41. The cutlery receptacle according to claim 38, wherein the aids comprise continuations provided with hook-shaped ends, wherein the hooks of the hook-shaped continuations are each aligned in the same direction.

42. The cutlery receptacle according to claim 42, wherein the hook-shaped continuations are aligned substantially perpendicularly to a direction of insertion in which the cutlery pieces are inserted into the cutlery receptacle.

43. The cutlery receptacle according to claim 42, wherein the hook-shaped continuations are arranged on cross struts which preferably extend from one side of the cutlery receptacle to the opposite side of the cutlery receptacle.

44. The cutlery receptacle according to claim 43, wherein a number of cross struts having hook-shaped continuations are provided, these being preferably arranged at equal distances on the cutlery receptacle.

45. The cutlery receptacle according to claim 43, wherein the hook-shaped continuations are each arranged on opposite sides and preferably in pairs on the cross struts.

46. The cutlery receptacle according to claim 43, wherein the hook-shaped continuations are arranged at equal distances on the cross struts.

47. The cutlery receptacle according to claim 38, wherein the cutlery receptacle has regions with different insertion depths.

48. The cutlery receptacle according to claim 38, wherein the cutlery receptacle has a handle that preferably projects upwards over the cutlery receptacle.

49. The cutlery receptacle according to claim 38, wherein at least one side wall of the cutlery receptacle can be folded upwards and preferably engages with at least one of the remaining side walls of the cutlery receptacle.

50. The cutlery receptacle according to claim 49, wherein cross struts each having hook-shaped continuations are provided both on the hinged side wall and also on the opposite side wall of the crockery basket, which cross struts are preferably arranged in such a manner that in the closed position of the hinged side wall they are positioned parallel and at uniform distances from one another.

51. The cutlery receptacle according to claim 38, wherein the cutlery receptacle can be inserted in a crockery basket mountable in the interior of a dishwashing machine having an access opening for permitting access to the interior of the dishwashing machine with the crockery basket including a main body area in which items to be washed can be placed, the main body area being delimited by a pair of opposed side walls, a rear wall, and a front wall and the crockery basket being withdrawable outwardly at least partially from the interior of the dishwashing machine such that at least the front wall delimiting the main body area moves outwardly through the access opening of the dishwashing machine, and at least one stacking device for arranging items to be washed in a dishwashing machine is which the crockery basket may be mounted, the stacking device being pivotally mounted to a side of the crockery basket delimiting the main body area such that the stacking device can pivot relative the main body area and the stacking device including a holder in which at least one separate cutlery receptacle is inserted.

52. A dishwashing machine, comprising:
a washing compartment; and
a crockery basket mountable in the interior of the washing compartment, the crockery basket having an access opening for permitting access to the interior of the dishwashing machine with the crockery basket including a main body area in which items to be washed can be placed, the main body area being delimited by a pair of opposed side walls, a rear wall, and a front wall and the crockery basket being withdrawable outwardly at least partially from the interior of the dishwashing machine such that at least the front wall delimiting the main body area moves outwardly through the access opening of the dishwashing machine, and at least one stacking device for arranging items to be washed in a dishwashing machine is which the crockery basket may be mounted, the stacking device being pivotally mounted to a side of the crockery basket delimiting the main body area such that the stacking device can pivot relative the main body area and the stacking device including a holder in which at least one separate cutlery receptacle is inserted.
